(19) United States
(12) Patent Application Publication
(10) Pub. No.: US 2008/0089321 A1
(43) Pub. Date: Apr. 17, 2008

(54) Electronic Switch Architecture and Method having Multiple Ports Coupled by a Single Data Link for Transferring Different Data Types Across the Link

(75) Inventors: Godwin Gerald Arulappan, Pondicherry (IN); Vatan Kumar Verma, Bangalore (IN)

Correspondence Address: DAFFER MCDANIEL, LLP;M/S: 5298, P.O. BOX 684908, AUSTIN, TX, 78768-4908, US

(73) Assignee: CYPRESS SEMICONDUCTOR CORP., San Jose, CA (US)

(21) Appl. No.: 11/564,914

(22) Filed: Nov. 30, 2006

(30) Foreign Application Priority Data
Oct. 17, 2006 (IN) 1911/CHE/2006

(51) Int. Cl. H04L 12/50

(52) U.S. Cl. 370/386; 370/458

(57) ABSTRACT

A switch circuit, system, and method are provided in which a single, shared data line is formed across the majority of the monolithic substrate which bears the switch. The shared data line is serviced by multiplexers and corresponding state machines placed near the ports of the switch. The state machine determines which one of a plurality of data streams received on the corresponding ports are to be serviced and placed in a first timeslot of multiple timeslots sent across the shared data path. A multiplexer select input responds to the state machine output by forwarding the selected data stream for a duration set by a timer within the state machine. An arbiter within the corresponding state machine determines which port is to served first and which data is to be placed in the first timeslot, but also can prioritize based on user-defined rules. One such rule would be to service isochronous data before non-isochronous data, and to maintain the temporal relationship between associated streaming input of that isochronous data.

### PRIORITY CLAIM

The present application claims priority to Indian Application No. 1911/CHE/2006 filed Oct. 17, 2006.

### BACKGROUND OF THE INVENTION

1. Field of the Invention

This invention relates to a communication system and, more particularly, to a switch architecture for switching different data types, such as streaming data, isochronous data and asynchronous (packetized or “bursty”) data between ports of the switch.

2. Description of the Related Art

The following descriptions and examples are given as background only.

Communication systems are generally well known as containing at least two nodes or end points, interconnected by a transmission line. An end point is any multimedia device that can send and/or receive data. Common examples include a computer, an audio/video receiver, multimedia players (CD and DVD players), telephones, etc. Depending on the type of multimedia device, different types of data can be sent or received. In addition to sending or receiving digital data, the transmission line can also send analog data. The data can arrive in different forms, hereinafter known as “data types.” For example, sophisticated transmission protocols can accommodate different data types, such as streaming data, packetized data, and control data.

Streaming data is data that has a temporal relationship between samples produced from a multimedia device. The relationship between those samples must be maintained across the transmission line to prevent perceptible errors, such as gaps or altered frequencies. A loss in the temporal relationship can cause a receiver to present jitter, echo or, in the worst instance, periodic blanks in the voice or video stream. Converse to streaming data, packetized data is data which need not maintain the sample rate or temporal relationship of that data. Instead, packetized data can be sent as disjointed bursts (i.e., “bursty” data) across the transmission line. The packets of data can be sent across the transmission line at virtually any rate at which the transmission line transfers data, and is not dependent in any fashion on any sampling frequencies since packetized data is generally recognized as non-sampled data.

Depending on the time relationship between the sampling rate and the transmission line transfer rate, the streaming data can be considered as either synchronous data or isochronous data. Synchronous streaming data is sent across the transmission line in sync with the rate by which the streaming data is sampled. However, the transmission line may transfer data at a different rate than the rate at which the multimedia streams or “samples” data. In order to maintain the temporal relationship between samples of the streaming data, isochronous transfer protocols are needed to accommodate those differences in order for the isochronous data to be played at the destination without perceptible gaps, errors, jitter, or echo.

An optimal transmission line can transfer different types of data. Coupled to the transmission line, which can be either copper wire, optical fiber, or wireless, are multiple multimedia devices. For example, a telephone multimedia device can be used to send and receive voice information and, depending on differences in the sampling rates (i.e., “fs”) at the telephone and frame transfer rate (i.e., “FSR”) within the transmission line, the voice information can be either sent as isochronous data or synchronous data. Control information can be sent to the multimedia device to setup the transmission or to control the receipt of the streaming (isochronous or synchronous) data.

Many conventional transmission systems utilize what is known as point-to-point links. Specifically, each multimedia device is connected to a respective multimedia device by a dedicated link. This may involve numerous links between a plurality of downstream multimedia devices and a plurality of upstream multimedia devices. For example, even if there is only a single upstream device, four downstream devices will require four links connecting the transmit port of each respective downstream device to the single receive port of the upstream device. Those four links can traverse the entirety of the switch fabric. This form of architecture requires that all ports be interconnected to one another and independent data paths between each pair of ports. The multiple data paths consume considerable area on the monolithic substrate which forms the switching architecture and requires unduly long routing between the port pairs. In addition, the point-to-point links between respective pairs of ports do not support isochronous transfers. In other words, if an isochronous transfer is needed from one port to another, no priority is necessarily given to that transfer versus transfers between other port pairs. Thus, packetized data may be sent in lieu of isochronous data, thereby possibly breaking the temporal relationship needed for sending streaming data without periodic blanks in the voice or video stream.

It would be desirable to introduce a communication system having a switch that avoids point-to-point links and the independent data paths associated therewith. It would be also advantageous to be able to selectively prioritize transmission of a particular data type over other data types, or between a particular pair of multimedia devices over other device pairs. Introducing these advantages within a generalized switch, or with a PCI Express interconnect architecture, proves advantageous not only from a cost perspective, but also for the added performance benefit.

### SUMMARY OF THE INVENTION

The following description of various embodiments of a switching system, switch architecture, and methodology are not to be construed in any way as limiting the subject matter of the appended claims.

According to one embodiment, a switch is provided that avoids the point-to-point connectivity limitations of various conventional switches. Instead of requiring connectivity between the receive lane of each port of the switch to all other ports' transmit lanes, the present switch utilizes a single connectivity between the receive lane of each port and all transmit lanes of other ports. Thus, a single data path provides connectivity from all receive lanes of each downstream port to all transmit lanes of the upstream ports. A single data path also provides connectivity between all receive lanes of the upstream ports to all transmit lanes of the downstream ports. The present switch supports all downstream-to-upstream connectivity through a single data path, all upstream-to-downstream connectivity through a single data path, and furthermore provides downstream-to-downstream or upstream-to-upstream (i.e., “peer-to-peer”) connectivity through a combination of the up and down data path. Instead of having data paths which number proportional to the number of downstream or upstream ports, the present switch utilizes a maximum of two data paths for sending downstream-to-upstream communication, upstream-to-downstream communication, and/or peer-to-peer communication. Two data paths on a monolithic substrate not only consumes less area, but also lessens the parasitic capacitance between data paths, interference between data paths, and the overall cost of the silicon area.

According to another embodiment, sequential logic or state machines can be used to control the transfer of data between the upstream and downstream ports. State machines ensure upstream-to-downstream connectivity independent from downstream-to-upstream connectivity, and allows for data to be communicated simultaneously from upstream-to-downstream ports and downstream-to-upstream ports. If peer-to-peer connectivity is desired, the state machines ensure the peer-to-peer connectivity is given lower priority to prevent interference with the upstream-to-downstream or downstream-to-upstream communication. Thus, two primary state machines can be used to handle all upstream-to-downstream communication and downstream-to-upstream communication. A secondary state machine, which slaves from the primary state machines, controls all peer-to-peer traffic. The secondary state machine preferably controls communication only when the primary state machines are inactive.

According to yet another embodiment, isochronous communication is given priority over non-isochronous communication, such as packetized or burst communication. Like packetized communication, isochronous communication is placed within a timeslot. The primary state machines, for example, sample the communication receive lane of the respective ports to determine what data type is present and the timing of those data types amongst all receive lanes. If data is present to be transmitted on a port, a request is raised to that state machine. The state machine then places the data associated with that request within a timeslot that is multiplexed onto the shared data path. If data is present as isochronous data upon a transmitting port, then priority is given to the isochronous data even though a request may also be concurrently present for non-isochronous data transfer on another port. The isochronous data is placed within a timeslot and transmitted immediately over the shared data path. If more than one isochronous request is present at the same time, then an arbiter may be chosen to select which isochronous data will be transmitted. Thus, an arbiter within each state machine gives mastership to one request over another depending upon an arbitration rule stored in local memory. Isochronous data can be detected using various mechanisms. For example, a coding violation may be used to signal the beginning of isochronous data. Once a decoder detects that coding violation, then isochronous data is known to be present and can be transferred immediately—ahead of non-isochronous data which may also be present on another port at the same time.

### BRIEF DESCRIPTION OF THE DRAWINGS

Other objects and advantages of the invention will become apparent upon reading the following detailed description and upon reference to the accompanying drawings in which:

FIG. 1 is a block diagram of a plurality of multimedia devices interconnected by a communication system having a switch with multiple data paths dedicated between each pair of ports within the switch;

FIG. 2 is a block diagram of a switch with only one data path for conveying data of different types among all ports of the switch;

FIG. 3 is a block diagram of a state machine that controls data sent from a DS port to an US port, or between DS ports;

FIG. 4 is a block diagram of a state machine that control data sent from an US port to a DS port;

FIG. 5 is a flow diagram of the operational states for the state machine that sends data from a DS port to an US port, or between DS ports;

FIG. 6 is a flow diagram of the operational states for the state machine that sends data from an US port to a DS port; and

FIG. 7 is a block diagram of various data types sent in dissimilar timeslots across the data path.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

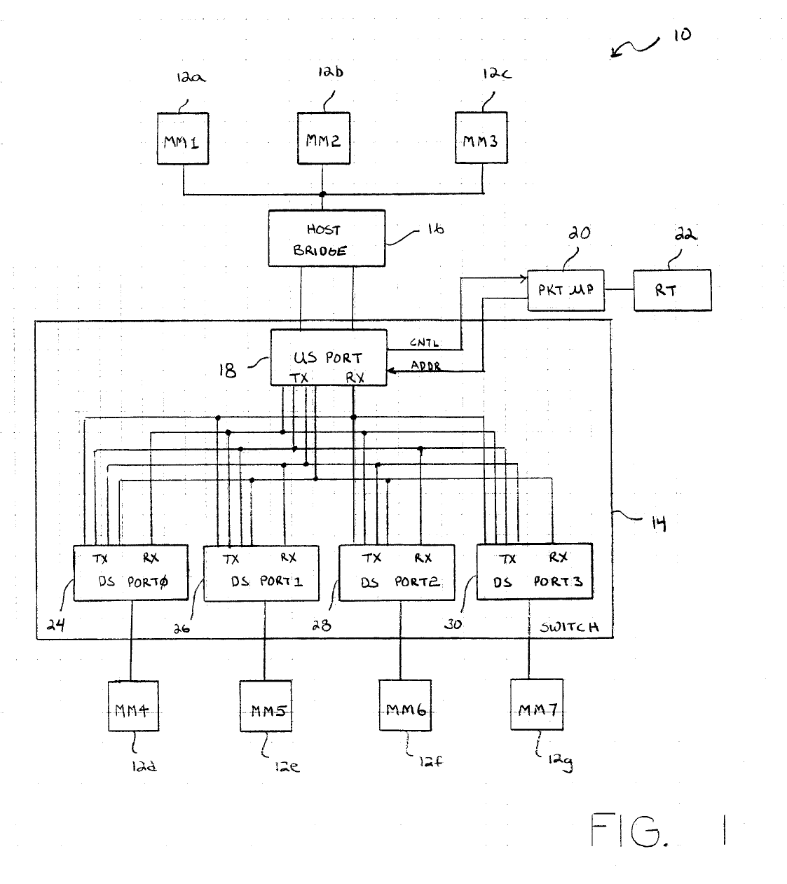

Turning now to the drawings, FIG. 1 illustrates a communication system 10. System 10 includes an interconnected plurality of multimedia devices 12. For sake of brevity and clarity in the drawings, only seven multimedia devices are shown. However, it is understood that system 10 can include more or less than seven multimedia devices, and can also include more or less corresponding ports of switch 14. The backbone of system 10 can be of any configuration, such as a bus, star, or any other topology available to a network.

A host device 16 can include a bus bridge used to send and receive data from an upstream port 18 of switch 14. The bridge within host 16 can receive data from port 18 and convey the data to the proper destination device 12a-c. Conversely, bridge 16 can convey data from the appropriate device 12a-c to port 18. Bridge 16 can suffice as a bridge between a local bus (local to devices 12a-c) and the bus architecture connected to switch 14. As will all bridge devices, bridge 16 interfaces different bus transfer protocols between the buses to which it interconnects.

Data sent from one port to another within switch 14 is routed using, for example, a packet processor 20 and routing tables 22. For example, as data leaves devices 12d-g, the data may contain a control signal as to a particular destination address to which that data must be sent. The destination address can be received as a control signal upon the packet processor 20. Packet processor 20 fetches a database from memory containing the routing tables that were previously configured therein. The destination address is compared against the database to determine where the associated packet is to be sent. Packet processor 20 returns an address to port 18, allowing the associated data to be sent to the appropriate device 12a-c, for example, via bus bridge 16. The combination of database searching via packet processor 20 and the database stored in memory which forms the routing tables 22 is oftentimes referred to as an address resolution unit. If switch 14 is a PCI-Express switch, the packet header contains the address information. The configuration registers of the switch hold the routing tables. The packet processor in the switch returns the address to port 18 and based on the routing information in the registers the packet is sent to the appropriate device.

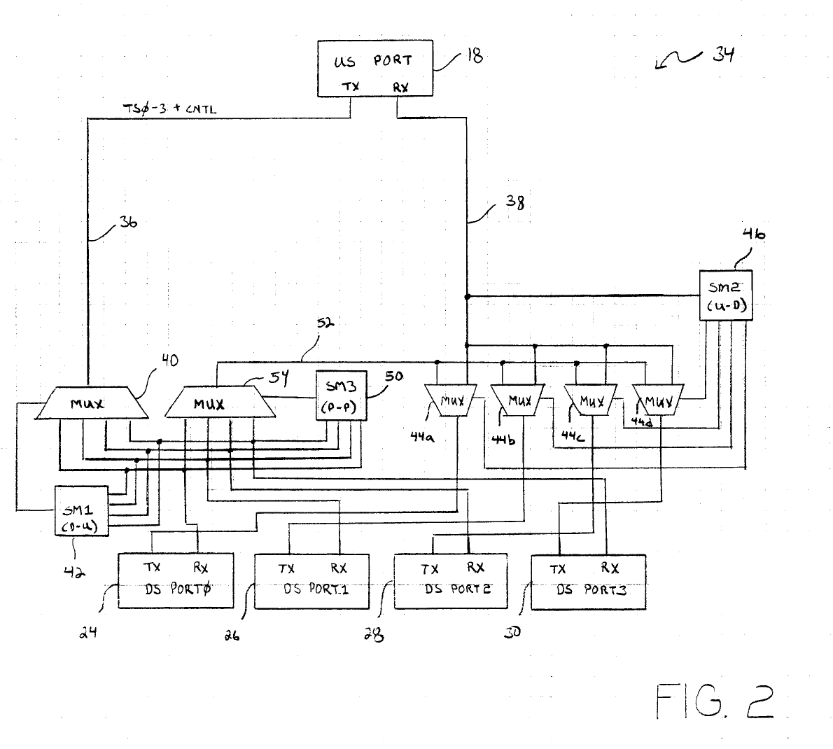

As shown in FIG. 1, each port is connected to each of the other ports using a dedicated line or link. For example, the receive lane of downstream (DS) port 0 is connected to the transmit lanes of all of the other ports (the receive lanes of DS ports 1-3 and the transmit lane of US port 18). DS ports 0-3 are labeled as reference numerals 24, 26, 28, and 30, respectively. Certainly, more or less downstream ports are contemplated, and more than a single upstream port is contemplated. However, for sake of brevity in the drawings, only five ports are shown. By having a dedicated link between pairs of each of the ports, the overall routing conductors upon a monolithic substrate are increased. If switch 14 is formed as an integrated circuit, the crosstalk and interconnect coupling can be fairly large, and the overall cost of added substrate area can also be large. It would be more preferred that a shared conductor be used between the downstream ports and the upstream port, another shared conductor between the upstream port (or ports) and the downstream ports, and yet one other single conductor between all downstream ports. Furthermore, if there is more than a single upstream port, a single conductor can be used to connect all upstream ports with one another. In a PCI Express topology, however, a single upstream port is generally used to service multiple downstream ports. However, it is recognized that switch 34 (FIG. 2) can be used in a far broader implementation than simply a PCI Express interconnect topology.

Turning to FIG. 2, switch 34 can be placed on a single monolithic substrate with an upstream port 18 and serviced by two data conductors 36 and 38. Conductors 36/38 carry data of different types serially across the conductor. Data from, for example, downstream ports 24-30 are multiplexed by a multiplexer 40 onto data path 36. Multiplexer 40 is controlled by a first primary state machine 42. Data sent from port 18 onto conductor 38 can also be placed serially onto a set of multiplexers 44 which are controlled by a second primary state machine 46. State machine 42 determines which, from among datum sent from the receive lanes of ports 24-30, are to be sent onto data line 36. State machine 42 services data requests based on an arbitration rule, but in each instance with higher priority to isochronous data. If both data types request access to conductor 36, isochronous data will be placed in its timeslot and sent across conductor 36 before the non-isochronous data. If, for example, non-isochronous data (i.e., packetized data) is being sent in a timeslot meant for isochronous data, state machine 42 is capable of servicing the isochronous data for transmission across data bus 36 immediately on the next packet boundary of the non-isochronous data interrupting it.

State machine 46 includes a controller and a timer. The controller receives the incoming data from conductor 38 and from the destination address, and forwards a control signal for a particular timeout period equivalent to the programmed isochronous timeout for the particular address to the select pin of the corresponding multiplexer 44a-d. The selected multiplexer will then forward that data to the appropriate downstream port. A third state machine 50 operates also as a primary state machine similar to state machine 42, by receiving data and placing the data upon conductor 52 via multiplexer 54 according to arbitration rules fetched by state machine 50. The data upon conductor 52 can then be sent from one downstream port to another downstream port, with multiplexers 44a-d being appropriately selected by state machine 50.

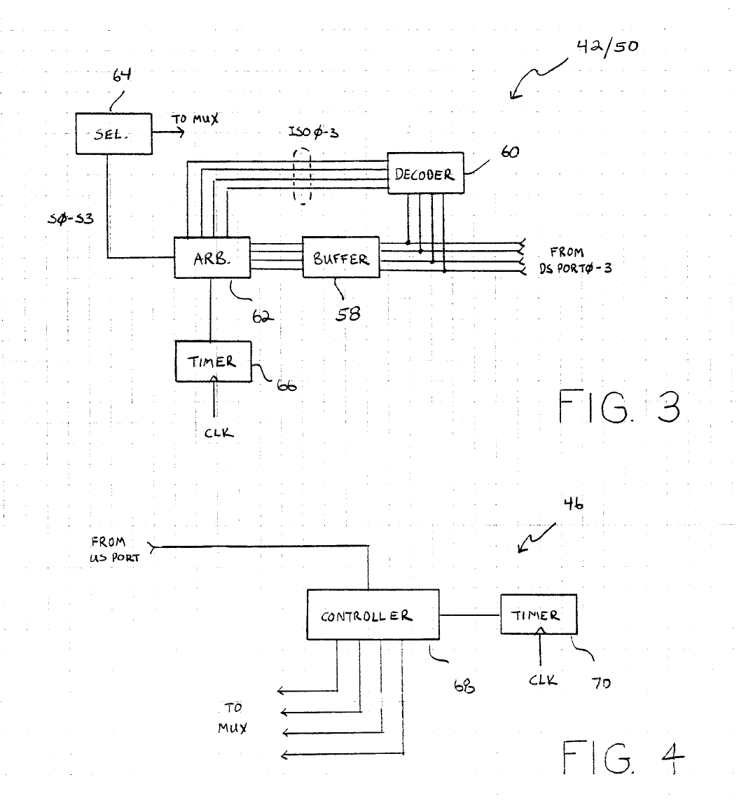

Turning now to FIG. 3, state machine 42/50 is shown according to one example. As data arrives from the downstream port, a buffer 58 may temporarily hold that data, and a decoder 60 may be used to decode any encoded signaling byte, for example. The decoded signaling byte may indicate a particular data type, such as isochronous data, on the corresponding downstream port receive lane (ISO 0-3). If isochronous data is present and the timeslot is programmed to the corresponding address, then the isochronous data command (ISO 0-3) will be sent to the arbiter 62 for servicing the isochronous request before other data type requests. Arbiter 62 then forwards the appropriate signaling bit to a select unit 64, which places that signaling bit upon multiplexer 40/54 (FIG. 2). The multiplexer selects the conductor containing the isochronous data for passage onto the shared data line 36/52 (FIG. 2).

If isochronous data is not being requested from a downstream port, it may be that several packetized data may be requested at the same time. Arbiter 62 must decide based on the arbitration rules which packetized data is to be sent. If packetized data is requested on one port before another, the first request is serviced. However, if packetized data is sent on the receive lanes at the same time, then arbiter 62 must decide which request is to gain mastership over the other based on priority rules and a defined Quality of Service (QoS) protocol.

Isochronous data from the downstream ports are placed onto the shared data line or conductor 36 based on defined timeslots programmed in the configuration registers. For example, data from port 0 can be sent in the first two timeslots, and data from port 3 can be sent in a timeslots 4,5 and 6 following the first timeslot. Each timeslot if of fixed duration and the number of timeslots allocated to each egress port may vary depending on the programming The length of that timeslot is established through a timer 66, and the timed value sent with the timeslot (S0-S3) to the select unit 64, which maintains the select pin at its proper select value for the appropriate timed amount so as to send the entire data type from that port until, for example, an interrupt occurs or isochronous data must be serviced from another port.

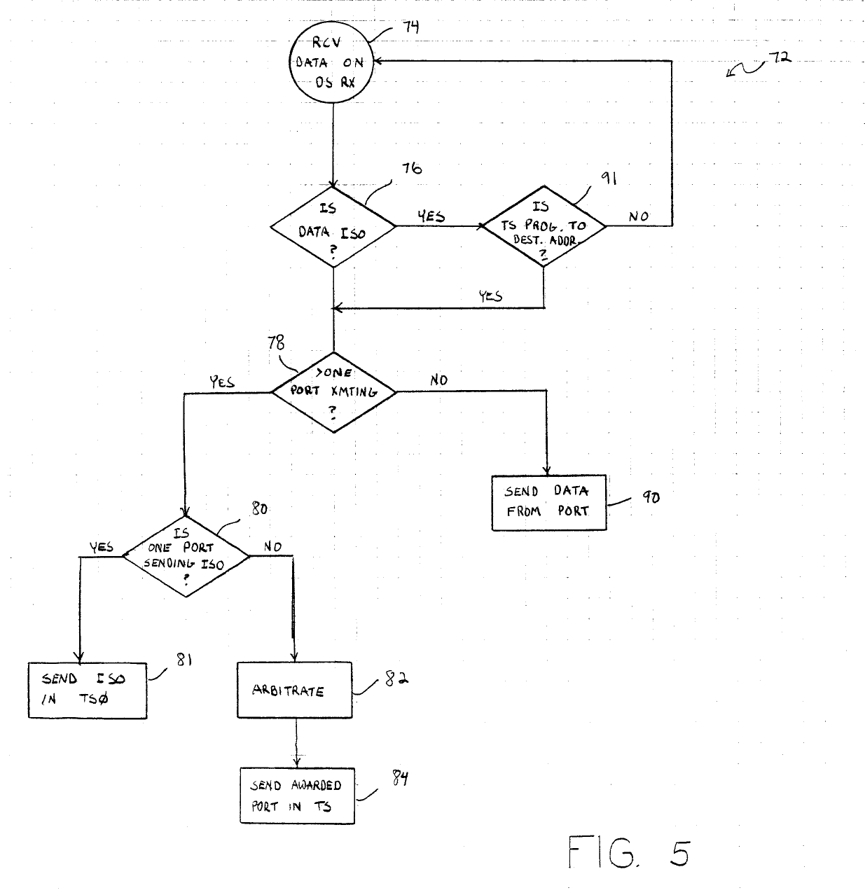

Referring to FIG. 4, state machine 46 may include a controller 68 and a timer 70. Controller 68 receives the data from data line 38 and the destination address associated therewith. Once the address is deciphered, controller 68 initiates the appropriate select signal to the appropriate multiplexer 44a-d (FIG. 2) to forward the corresponding data to the appropriate downstream port. Timer 70 is used to demarcate the timeslot needed to send associated isochronous data from, for example, upstream port 18 to the appropriate downstream port 24-30 (FIG. 2). If no isochronous data is available in a programmed timeslot or if a time slot is not programmed to transmit isochronous data, the timeslot can be utilized to transmit non-isochronous data based on arbitration rules that satisfy the programmed level of QoS

Referring to FIG. 5, a flow diagram 72 of operational states for state machine 42/50 is shown. Diagram 72 begins operation by receiving data 74 on the receive lane of one or more downstream ports. The receive data is forwarded as a request to the state machine 42/50. If the received data is isochronous data, the request is forwarded to the state machine only if the timeslot is programmed for the corresponding address. For non-isochronous data the request is forwarded immediately without any check. The state machine will then determine whether one or multiple requests are received, and whether the request is for isochronous data 76. If multiple requests are received, meaning multiple downstream ports are transmitting on the receive lane 78, then decision block 80 determines whether one of those ports is sending isochronous data. If one port is sending isochronous data, the isochronous data is placed in the first timeslot 81. Contemporaneous with receiving the first request, a timer can be set to establish the duration of that timeslot.

If more than one port is sending isochronous data, the arbiter within state machine 42/50 must arbitrate 82 to determine which request to service first. Arbitration rules establish the priority given to one request over another. The awarded port based on the arbitration rules is then given mastership of the shared data bus, and the data from that port is placed in the timeslot 84. Contemporaneous with receiving the first request, a timer is set. If only one port is transmitting data, then block 90 indicates that data is sent from the corresponding port, and the timer is set. If the received data contains isochronous data, then a determination must be made on whether the timeslot is programmed to a destination address, as shown by decision block 91. Diagram 72 corresponds to the operational states for sending data from a downstream port to an upstream port or for sending data between downstream ports.

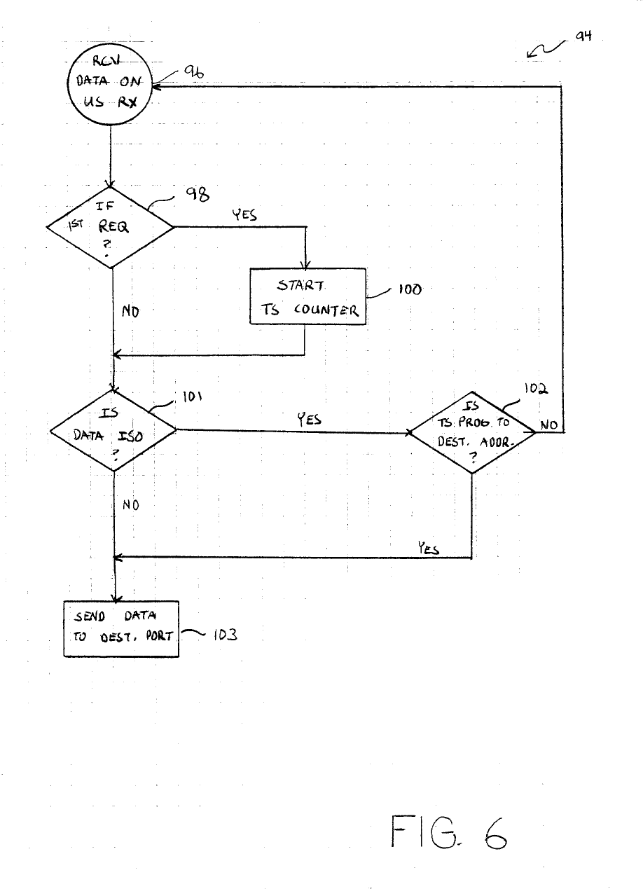

FIG. 6 illustrates a flow diagram 94 for state machine 46. The operational states begin by receiving data 96 sent from the upstream port upon the data conductor. That data contains both an address and a control signal received on the state machine. The timer within the state machine is set, and data is then sent to the designated port based on the received address. A determination must be made on whether the request is the first request and, if so, a timer is started, as shown by decision blocks 98 and 100. Also, similar to FIG. 5, a determination must also be made on whether the received data is isochronous data. If so, determination is made on whether the timeslot is programmed to a destination address, as shown by decision blocks 101 and 102. If the data is not isochronous data, then the data is sent to the corresponding, respective, destination port as shown by block 103.

If isochronous data is received at the upstream port, the request is forwarded to the state machine only if the timeslot is programmed to the corresponding downstream port address. Thus the uniformity of the isochronous data is maintained to the downstream port. The downstream port always receives isochronous data at the uniform rate that has been programmed. In between the isochronous packets, any non-isochronous packets received are sent. This transmission is interrupted at a packet boundary once an isochronous request is received. Through individual isochronous packets may be slightly delayed, the uniform rate is maintained over time.

Sending of isochronous and non-isochronous presents many challenges. For example, if the sampling rate of the multimedia device placing isochronous data upon the shared data path is 44.1 KHz, it is important that between sending one portion of isochronous data and sending another portion of isochronous data, the time duration there between does not exceed 1/44.1 KHz. In this manner, it may be that the various data types are sent in frames with possibly four segments per frame, and the frame sync rate (FSR) can be 44.1 KHz per frame. This allows one segment of isochronous data to be sent per frame and no gaps are guaranteed to exist between streaming data. Depending on the sample rate, the frame sync rate can be adjusted as long as the transfer rate across the shared data path is much higher than the sample rate of the data coming from the multimedia device. In this fashion, multiple multimedia devices can transfer at the same time across the shared data path.

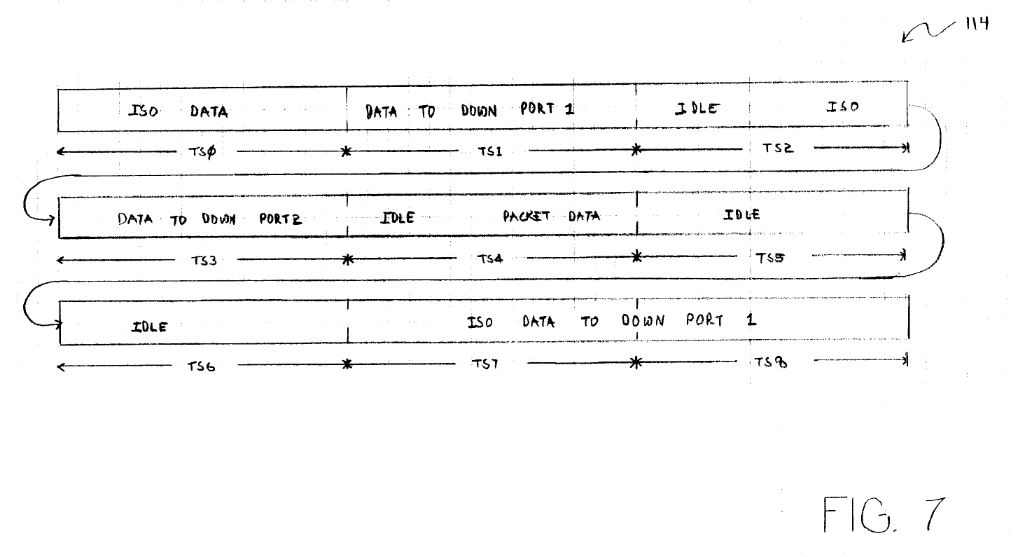

FIG. 7 illustrates different data types shown in sequence as conveyed across the shared data path. The multiple data types 114 can be arranges in various sequences. For example, isochronous data to downstream port 1 can be received and if timeslots TS0 and TS1 are programmed for downstream port 1, this data is placed in the first timeslot TS0. If TS2 and TS3 are programmed for downstream port 2 isochronous data (even if the request is delayed the moment the request for isochronous data for downstream port 2 is received) transmission is begun. Non-isochronous data is only transmitted when no isochronous is present and it is not aligned to any timeslot boundary. If isochronous data for downstream 1 is received during TS6 but the programming is set only for TS7 and TS8, the start of isochronous data is delayed till TS7.

It will be appreciated to those skilled in the art having the benefit of this disclosure that this invention is believed to provide improved data transmission over a shared data line or link. The multiplexers and state machines are placed near the ports at which they service, allowing a single data line or link to run the majority of silicon area to minimize monolithic substrate space, and reduce capacitive cross-coupling if multiple point-to-point lines are used in lieu of the shared data line. Isochronous and non-isochronous data can be sent across the shared line with arbitration precedent given to the isochronous data, or to any data type or particular port that a user selects based on a desired QoS. Further modifications and alternative embodiments of various aspects of the invention will be apparent to those skilled in the art in view of this description. It is intended that the following claims be interpreted to embrace all such modifications and changes and, accordingly, the specification and drawings are to be regarded in an illustrative rather than a restrictive sense.

What is claimed is:

1. A switch circuit, comprising:
a plurality of downstream ports;
an upstream port;
a primary state machine coupled to the plurality of downstream ports for determining which one of a plurality of data streams received upon the respective plurality of downstream ports is to be placed within a first timeslot before others of the plurality of data streams; and
a multiplexer coupled to and controlled by the state machine to forward said first timeslot of data across a single data line to the upstream port.

2. The switch circuit as recited in claim 1, wherein the multiplexer comprises a plurality of inputs and a select input, and wherein the plurality of inputs are coupled to the plurality of downstream ports and the select input is coupled to an output of the primary state machine.

3. The switch circuit as recited in claim 1, wherein the primary state machine comprises an arbiter coupled to a memory device for fetching a priority rule from the memory device for determining which one of the plurality of data streams received upon the respective plurality of downstream ports is to be placed within the first timeslot.

4. The switch circuit as recited in claim 1, wherein the other of the plurality of data streams are placed in respective other timeslots and sent across the single data line after the first time slot.

5. The switch circuit as recited in claim 1, wherein the primary state machine comprises a decoder for detecting whether said one of the plurality of data streams is isochronous data and for placing within the first timeslot the isochronous data before others of the plurality of data streams.

6. The switch circuit as recited in claim 1, wherein the primary state machine comprises a timer for setting a length of time for the first timeslot before resetting the timer for setting a length of time for the next timeslot to accompany the next of the other of the plurality of data streams.

7. A switching system, comprising:
a plurality of downstream ports;
a multiplexer having an input coupled to the plurality of downstream ports;
an upstream port coupled to an output of the multiplexer;
a memory device; and
an primary state machine coupled to a select input of the multiplexer and the memory device for fetching a rule from the memory device for controlling which downstream port will forward data to the upstream port.

8. The switching system as recited in claim 7, wherein the rule comprises forwarding isochronous data before non-isochronous data.

9. The switching system as recited in claim 7, wherein the rule comprises forwarding the first data in time.

10. The switching system as recited in claim 7, further comprises:
a second multiplexer; and
a secondary state machine coupled to a select input of the second multiplexer and the memory device for fetching a second rule from the memory device for controlling which downstream port will forward data to which downstream port.

11. The switching system as recited in claim 10, wherein the second rule comprises forwarding isochronous data before non-isochronous data.

12. The switching system as recited in claim 10, wherein the second rule comprises forwarding the first data in time, except if one of the plurality of downstream ports is forwarding data to the upstream port.

13. The switching system as recited in claim 7, further comprises:
a set of multiplexers; and
a ternary state machine coupled to a select input of the each of the set of multiplexers and the memory device for fetching a third rule from the memory device for controlling which downstream port of the plurality of downstream ports will receive data from the upstream port.

14. The switching system as recited in claim 10, wherein the third rule comprises forwarding isochronous data before non-isochronous data.

15. The switching system as recited in claim 10, wherein the third rule comprises forwarding the first data in time.

16. A method for transmitting data, comprising:
receiving a plurality of data streams on a respective plurality of downstream ports;
determining which of the plurality of data streams to forward to an upstream port, with priority given to forwarding isochronous data before non-isochronous data; and
setting a timer for each timeslot in which the respective plurality of data streams are forwarded, and forwarding the plurality of data streams is successive timeslots.

17. The method as recited in claim 16, wherein said receiving further comprises receiving at least one data stream on a respective at least one upstream port.

18. The method as recited in claim 17, wherein said determining further comprises determining which of the plurality of downstream ports to forward said at least one data stream in timeslots assigned to the respective plurality of downstream ports.

19. The method as recited in claim 16, further comprises sampling isochronous data and forwarding said isochronous data to at least one of the plurality of downstream ports.

20. The method as recited in claim 16, wherein said isochronous data is sampled at a bit rate substantially equal to the rate at which the isochronous data is forwarded to the upstream port.
